(19) United States
(12) Patent Application Publication
(10) Pub. No.: US 2009/0001019 A1
(43) Pub. Date: Jan. 1, 2009

(54) Fluid Treating Apparatus

(75) Inventors: Ariel Frometa, Everett, MA (US); Christopher Wargo, Wellesley, MA (US); Joseph Zahka, Andover, MA (US); Yasuji Suzuki, Tokyo (JP)

Correspondence Address: MYKROLIS CORPORATION, 129 CONCORD ROAD, BILLERICA, MA, 01821-4600, US

(73) Assignee: MYKROLIS CORPORATION, Billerica, MA (US)

(21) Appl. No.: 11/628,278

(22) PCT Filed: Jun. 3, 2005
(86) PCT No.: PCT/US2005/019679

§ 371 Date: Jan. 28, 2008

Related U.S. Application Data
(60) Provisional application No. 60/577,119, filed on Jun. 3, 2004.
(60) Provisional application No. 60/586,067, filed on Jul. 7, 2004.

(51) Int. Cl. B01D 35/01; B01D 65/00; B01D 61/30; B01D 61/10; B01D 61/20; B01D 61/00; B01D 19/00

(52) U.S. Cl. 210/637; 210/188

(57) ABSTRACT

Embodiments of the present invention are directed to an apparatus that can be used to treat fluids. The apparatus can include a housing with an inlet for receiving a process fluid to be treated, a surface within the housing for treating the process fluid that can be wet by the process fluid, and an outlet for removing treated process fluid. The housing includes a vent that aids in the removal of fluid components that separate from the process fluid. Removal of these separated fluids improves the efficiency and contact of the process fluid with the surfaces in the housing for treating the process fluid.

### CROSS REFERENCE TO RELATED APPLICATIONS

This application claims the benefit of and priority to U.S. Provisional Application Ser. No. 60/577,119 filed Jun. 3, 2004 and U.S. Provisional Application Ser. No. 60/586,067 filed Jul. 7, 2004 the contents of each are incorporated herein by reference in their entirety.

### BACKGROUND

Flat sheet, hollow fiber, and other microporous membranes can be used in particle filtration, contamination removal, heat and mass transfer, and cross flow particle filtration devices. In these applications the microporous membranes have a high surface area, and the pores form a torturous path and have a high surface area to volume ratio.

The control of particulate and or molecular contaminants in manufacturing processes used in the semiconductor, pharmaceutical, or other industries may require the use of filters having membranes that remove submicron particles, molecular contaminants, or bacteria. Particles, for example, that are deposited on a semiconductor wafer can produce defects when the particle is as small as about one tenth of the smallest feature of the semiconductor chip. Membrane filters can be used to remove these contaminants from the liquids and gases that are used in various manufacturing processes for these industries.

In filtration, purification, and fluid conditioning applications, it is advantageous that the fluid being treated wet the membrane and its pores. In heat and mass transfer applications utilizing thin walled non-porous hollow tubes it is also advantageous for the fluid to wet the tubes in order to fully utilize the surface area of the contactor. In use when a porous membrane which is not spontaneously wet by a fluid becomes dewet, the pores of the membrane can fill with gas which reduces the contact area of the fluid with the membrane. Where the fluid and membrane have similar surface energy wetting is spontaneous or dewetting of the membrane is not favored and fluid remains in the membrane pores and excludes gases.

Fluid filtration or purification is usually carried out by passing the process fluid through the membrane filter under a differential pressure across the membrane which creates a zone of higher pressure on the upstream side of the membrane than on the downstream side. Thus, liquids being filtered in this fashion experience a pressure drop across the membrane filter. This pressure differential can result in the liquid on the upstream side having a higher level of dissolved gases than the liquid on the downstream side. This occurs because gases, such as air, have greater solubility in liquids at higher pressures than in fluids at lower pressures. As the liquid passes from the upstream side of the membrane filter to the downstream side, dissolved gases can come out of solution in the membrane resulting in outgassing of the liquid. Outgassing of a liquid can also occur spontaneously without a pressure differential, as long as the liquid contains dissolved gases and there is a driving force for the gases to come out of solution, such as nucleating sites on the surfaces of a membrane, particles, a temperature change, or housing surface where gas pockets can form and grow.

Out gassing liquids typically used in the manufacture of microelectronic devices, pharmaceuticals, display devices and other articles of manufacture can include very high purity water, ozonated water, hydrogen peroxide containing fluids, organic solvents such as alcohols, and others liquids which are chemically active, such as concentrated and aqueous acids or bases which can contain an oxidizer.

Fluorine-containing polymers are well known for their chemical inertness, or excellent resistance to chemical attack. One disadvantage of fluorine-containing polymers is that they are hydrophobic and therefore membranes made from such polymers can be difficult to wet with aqueous fluids or other fluids which have surface tensions greater than the surface energy of the membrane. A problem often encountered during the filtration of outgassing liquids with a hydrophobic membrane filter is that the membrane provides nucleating sites for dissolved gases to come out of solution under the driving force of the pressure differential during the filtration process. Gases which come out of solution at these nucleating sites on the hydrophobic membrane surfaces, including the interior pore surfaces and the exterior or geometric surfaces, can form gas pockets which adhere to the membrane. As these gas pockets grow in size due to continued outgassing, they can begin to displace liquid from the pores of the membrane, ultimately reducing the effective filtration area of the membrane. This phenomenon is usually referred to as dewetting of the membrane filter since the fluid-wetted, or fluid-filled portions of the membrane are gradually converted into fluid-nonwetted, or gas-filled portions where filtration ceases and which results in a reduction of the overall filtration efficiency of the filter. In order to wet the surface of a hydrophobic membrane with water or an aqueous fluid, one current practice to first wet the surface with an organic solvent, followed by contact of the surface with a mixture of water and an organic solvent and then followed by contact with water or an aqueous fluid. These processes can be time consuming and result in generation of chemical waste.

One approach to prevent the dewetting of hydrophobic membranes with outgassing aqueous fluids is to use surface modified membranes that do not permit gas to displace fluid in the pores or on the surface of the membrane. These membranes can spontaneously wet upon contact with an aqueous liquid so that a treatment process for wetting its surface is not required. Alternatively, some membranes which are not spontaneously wetting do not fill with air after the chemical is drained from their housing; they remain wet by the chemical. For spontaneously wetting membranes no prior treatment with an organic solvent or pressure intrusion, or mechanical energy such as by stirring, is required in order for the membrane surface to be wet with water. These membranes also remain wet by similar surface energy fluids after it has been drained from its housing. Membranes that remain wet with a fluid can accumulate a separated fluid such as a gas in the housing that holds the membrane. Because the pores of the membrane have surface energy similar to the fluid, gas that accumulates in the housing can block the membrane from liquid and effectively increase pressure drop due to the reduced fluid contact with the porous membrane.

There exists a need to remove fluid that separates from a process fluid and accumulates in the exchange device housing during treatment with the exchange device. Removal of these separated fluids from the exchange device housing would increase the contact area of the process fluid with the exchange device surface in the housing. Efficient removal of these separated fluids from the exchange device would lead to greater uptime for equipment, improved productivity, and minimize generated chemical waste.

### SUMMARY

One embodiment of the present invention is an apparatus that can include a housing having a feed fluid inlet, a fluid conditioning device or structure within the housing, and a fluid outlet. The fluid conditioning device may be a heat or mass transfer device, and can be a high surface area porous membrane for removing contaminants from a fluid. The fluid conditioning device may be connected to a portion of the housing that is in the flow path between the housing feed fluid inlet and housing fluid outlet. The apparatus may include a feed side vent between the feed fluid inlet the fluid conditioning device, the vent is configured so that an inlet of the feed side vent is positioned within the housing where the fluid velocity permits venting of a less dense fluid like a gas that separates from the feed fluid in the housing. The apparatus may also include a core vent that can vent a separated fluid (less dense from the feed fluid) from the core. One non-limiting example of such an apparatus includes a surface modified porous membrane particle filter wet by an aqueous process fluid where a gas in the process fluid separates from the fluid and accumulates in the housing. The apparatus has a vent located in the housing at a region of low fluid velocity so that separated gas from the feed fluid is removed from the housing and that more surface area of the porous membrane is exposed to the fluid rather than blinded by the gas. Another non-limiting example of an apparatus is a thermoplastic material that is a porous membrane used to remove particles or others contaminants from the feed fluid. The porous membrane can be wet by the feed fluid or will not allow feed fluid in the membrane to be displaced by a separated fluid. The housing of the apparatus has a vent for separated gas on the feed side of the membrane located in a position of the housing where fluid velocity is lower than the fluid velocity inlet to the housing; the housing may also have a vent on the permeate side of the membrane to vent gas from the core or lumens of the membrane.

An embodiment of the present invention is an apparatus that includes a housing having a feed fluid inlet and a permeate fluid outlet forming a flow path, a porous membrane connected to a portion of the housing that is in the flow path between the inlet and outlet through which feed fluid passes, a feed side vent between the feed fluid inlet and a first side of the porous membrane that is configured with a separator so that an inlet of the feed side vent is positioned within the housing where the fluid velocity is low enough to permit accumulation and or venting of a fluid that separates from the feed fluid. The porous membrane can be wet by the feed fluid or will not allow feed fluid in the membrane to be displaced by a separated fluid. The housing can include an optional core vent that can vent a separated fluid (less dense from the feed fluid) from the core The separator may an insert, molded, or bonded into the housing. The porous membrane may be a filtration and or purification cartridge and can comprise separate elements that mate together by a sealing mechanism or the filtration and or purification cartridge may be bonded together with the housing to form a disposable unit having a unitary structure. The porous membrane can be wet by the feed fluid. The porous membrane can remove particles, dissolved ions or other molecular, or a combination including these contaminants from a feed fluid. The membrane in one embodiment is a particle filter. The apparatus vent may include a separator that is an insert for modifying the position of the vent inlet to a position or region within the housing where separated fluid accumulates. The separator provides a fluid passage in the housing that is at a position or region within the housing where the fluid velocity is below 150 cm/sec when the an inlet feed fluid flow is 20 lpm. The housing and vents or fluid fittings can be symmetrically placed about the housing.

One embodiment is an apparatus that can include a fluid conditioning structure in a housing, the housing can include a fluid inlet and a fluid outlet. The fluid conditioning structure has a feed side and an outlet side and is connected to the housing in a manner which prevents mixing of a feed fluid inlet to the housing and treated fluid from the fluid conditioning structure that is removed from the housing through the fluid outlet. The housing can also include an outlet vent capable of removing a separated fluid from the treated fluid and a separator that can remove separated fluid that accumulates in the housing on the feed side of the fluid conditioning structure. The separator provides a flow path from a region of the housing where the separated fluid from the feed fluid accumulates to the outside of the housing. In some embodiments the fluid conditioning structure includes a non-dewetting porous membrane. In some embodiments the membrane is stable and remains non-dewetting during use at temperatures of up to about 140° C., in some embodiments from about 50° C. to about 140° C., and in other embodiments the membrane is stable and remains non-dewetting during use at temperatures at or above about 180° C.

One embodiment is separator that is an insert having an inlet and an outlet capable of being placed in a vent of an exchange apparatus housing or manifold, the insert forming a fluid tight seal with the housing vent, the insert modifies the location of the inlet of the housing vent. In other embodiments an insert can be placed in a feed side vent of a housing that includes a fluid conditioning structure, the fluid conditioning structure connected to the manifold in a manner which prevents mixing of a fluid feed to the housing module and a treated fluid removed from the housing module. The insert provides an inlet to a flow path in a region of the housing where a fluid that separates from the feed fluid accumulates and the insert provides an outlet to the flow path for removing separated fluid from the housing. The shape, size, material, or a combination of these of the insert can be used to modify the position of the vent inlet within the housing or manifold to a position or region where fluid velocity within the housing is less than the fluid velocity inlet to the housing. The housing where the insert is positioned may include an optional core vent that can vent a separated fluid, less dense from the feed fluid, from the core. In one embodiment, the position of the insert forms one or more inlets to the vent that can be positioned in a region of the housing where the fluid velocity is less than about 150 cm/sec, and in some embodiments, less than about 12 cm/sec.

One embodiment is a kit that may include a separator that can be used to remove separated fluid that accumulates in the housing of a device that includes a fluid conditioning structure. The kit may include instructions for installing the separator into the housing. The kit may further include a fluid conditioning structure or a fluid conditioning structure in a housing.

An embodiment of an apparatus of the present invention may be used for exchanging energy or mass with a process fluid that contacts the fluid conditioning structure in the housing. The exchange device may be used in an apparatus that can include a source of process fluid inlet to a pump, the pump in fluid communication with the process fluid inlet on an exchange device. The exchange device has an inlet vent with a flow path to a region of the housing where a separated fluid from the process fluid accumulates. The outlet of the exchange device is in fluid communication with a substrate, a tank that holds an article, or other article to be treated by the process fluid. The exchange device may be used as part of a dispense system or a re-circulating fluid flow circuit. The substrate or article to be treated by the process fluid includes materials such as but is not limited to metals such as copper and aluminum, semiconductors including arsenic or silicon, and ceramics including aluminum, barium, and strontium, photolithographic resins and polyimides.

One embodiment is an apparatus that can include a housing having a feed fluid inlet, a non-dewetting porous membrane in the housing, and a fluid outlet. The non-dewetting porous membrane has a feed side and an outlet side, the housing and the non-dewetting porous membrane connected in a manner which prevents mixing of a feed fluid inlet to the housing and treated fluid from the non-dewetting porous membrane that is removed from the housing through the fluid outlet. The housing further comprises a feed side vent in fluid communication with the feed fluid inlet, an outlet vent capable of removing a separated fluid from the treated fluid, and a separator in fluid communication with feed fluid on the feed side of the non-dewetting porous membrane. The separator forms a flow path with an inlet in a region in the housing where a separated fluid accumulates and an outlet used to remove separated fluid from the housing.

One embodiment is a method for treating a fluid that includes the acts of contacting a fluid with a porous membrane in a housing and venting separated fluid from the housing. The housing includes an inlet vent or a separator positioned in the inlet vent within the housing, the housing containing a porous membrane, the housing having a fluid inlet and a fluid outlet with the porous membrane between the inlet and outlet such that fluid inlet to the housing passes through the porous membrane. The housing has an inlet vent, and optionally a core vent that can vent a separated fluid from the core. The inlet vent or a separator positioned in the inlet vent provides a passage from a region of the housing where separated fluid accumulates to the for venting the separated fluid from the housing through the inlet vent. The porous membrane can be wet by the feed fluid or will not allow feed fluid in the membrane to be displaced by the separated fluid.

Another embodiment is a method that can include the act of contacting a feed fluid with a fluid conditioning structure in a housing, the fluid conditioning structure has a feed side and an outlet side and the housing comprises a fluid inlet and a fluid outlet, the housing and the fluid conditioning structure connected in a manner which prevents mixing of the feed fluid inlet to the housing and fluid treated by the fluid conditioning structure removed from the housing through the fluid outlet. The housing further comprises an outlet vent to remove a separated fluid from the treated fluid. The method can further include the act of removing separated fluid that has accumulated in the housing on the feed side of the fluid conditioning structure with a separator that provides a flow path from a region of the housing where the separated fluid from the feed fluid accumulates, to the outside of the housing.

Advantageously embodiments of the invention permit the molding housings and manifold and separator that have a line of symmetry. This reduces costs for molds and makes housing fabrication easier and less costly. The ability to vent accumulating fluids that separate out from a feed fluid on passage into the housing of an apparatus having a porous membrane device or other exchange device provides a steady pressure drop and fluid flow rate through the membrane separation device enhancing process control and process uptime because accumulated separated fluid is reduced or eliminated. The ability to configure the housing for a membrane device in a bowl down configuration permits proper venting of both the core and housing from accumulated fluids like gases.

### DESCRIPTION OF THE DRAWINGS

In part, other aspects, features, benefits and advantages of the embodiments of the present invention will be apparent with regard to the following description, appended claims and accompanying drawings where:

FIG. 1 is an illustration of a separation device in a bowl down configuration;

FIG. 2 is an illustration of a separation device in a bowl up configuration;

FIG. 3 illustrates the effect of separated gas on pressure drop through a porous membrane that is wet by a process fluid and that inhibits gas flow through the membrane;

FIG. 4 is a non-limiting illustration of a device that can be inserted into a vent and can be used to effectively change the position of the vent in the housing from one of high fluid velocity to one of relatively lower fluid velocity; is an illustration of a separation apparatus illustrating a housing, chemical inlet, filter membrane, and upstream or inlet vent for removing gas bubbles from the apparatus housing;

FIG. 5 is an illustration of pressure drop through a porous membrane wet by a feed fluid in an exchange apparatus with and without an insert device for modifying or changing the position of the vent to one of relatively lower fluid velocity within the housing;

FIG. 6 is an illustration of an insert or molded portion of the housing that changes the position of the vent from its original position near the inlet to a position of lower fluid velocity in the exchange apparatus which allows separated gas bubbles from the fluid to escape from the housing;

FIG. 7 is an illustration of a device that can be used to modify the location of a vent in a housing and used to vent a separated fluid like a gas from the housing;

FIGS. 8A and 8B is an illustration of a separator insert (FIG. 7I) in a vent with the separator making contact with the vent walls to secure the insert and provide channels or passageways between the vent wall and features like beveled edges and rounded surfaces of the insert for passage of separated fluid from the housing.

FIG. 9 Illustrates a housing for an exchange apparatus with the insert of FIG. 7(F) shown being positioned in the vent;

FIG. 10 is an illustration of showing the insert being fit into the vent hole and portion of the annular region; a passage for passage of separated fluid a lower fluid velocity due to the separator insert shielding the passage from the inlet fluid flow;

FIG. 11 is a cut away illustration showing a portion of the separator insert in the vent.

FIG. 12 illustrates the differential pressure across porous membrane in an exchange apparatus that remains wet by the feed fluid in the presence of a separated gas where the inlet of the housing vent is at a position of relatively high fluid velocity (A) and where a separator that is a vent tube is located at a position of reduced fluid velocity (B) in the housing compared to (A);

FIG. 13 is an apparatus for conditioning a re-circulating fluid by filtration and heating, the fluid produces a gas, the gas being vented by a separator from the housing to the catch basin of the overflow tank;

### DETAILED DESCRIPTION

Before the present compositions and methods are described, it is to be understood that this invention is not limited to the particular molecules, compositions, methodologies or protocols described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “hollow tube” is a reference to one or more hollow tubes and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference. Nothing herein is to be construed as an admission that the invention is not entitled to antedate such disclosure by virtue of prior invention.

Embodiments of the present invention are directed to an apparatus that can be used to treat fluids. The apparatus can include a housing with an inlet for receiving a process fluid to be treated, a surface within the housing for treating the process fluid that is wet by the process fluid, and an outlet for removing treated process fluid. The housing includes a separator that aids in the removal of fluid components that separate from the process fluid. Removal of these separated fluids improves the efficiency and contact of the process fluid with the surfaces in the housing for treating the process fluid.

One embodiment of the present invention is an apparatus having a housing, a porous membrane surface for treating a fluid and a feed side vent that is configured so that an inlet to the feed side vent is positioned within the housing where the fluid velocity is low enough to permit accumulation and venting of a fluid that separates from the feed fluid flowing through the apparatus. The housing may have a core vent that can vent a separated fluid (less dense from the feed fluid) from the core The feed side vent can be located in a position of the housing that has lower fluid velocity than the velocity of fluid inlet into the housing. The separated fluid, for example a dissolved or generated gas that separates from an aqueous based feed fluid flowing through the housing and that is inhibited or cannot pass through the porous membrane, porous membrane is wet with feed fluid or can be a non-dewetting membrane, can accumulate in the housing. This separated fluid can be removed from the housing through the inlet to the vent, which can be a separator, the vent inlet located within the housing where the fluid velocity is low enough to permit accumulation and or venting of the separated fluid within the housing. The porous membrane may be used to purify or filter the process fluid.

One embodiment of the present invention is an apparatus including a housing and a porous membrane that removes or separates impurities from a feed fluid by flow of the feed fluid through the membrane. A separator within the housing provides for the removal of less dense fluids that become separated from the feed fluid and are unable to pass through the porous membrane. The separator in the housing aids in the removal of separated fluid from the housing and prevents accumulation of separated fluid within the housing. The separator can provides for a steady fluid flow and pressure drop across the porous membrane.

In one embodiment, the apparatus includes a housing with a vent that removes fluid separated from the feed fluid from the housing and keeps the separated fluid from reducing feed fluid flow through a porous membrane or reducing feed fluid contact with an exchange device in the housing. The housing or manifold can also include a core vent that can vent a separated fluid (less dense from the feed fluid) from the core of the porous membrane or other exchange device. The vent can be located or positioned in a portion of the housing having lower fluid velocity than the velocity of feed fluid inlet to the housing. The vent position permits the separated fluid to be removed from the housing. Alternatively the vent can be located anywhere in the housing and a separator inserted and fluidly sealed into the vent to provide fluid communication with a portion of the housing where the separated fluid that can obstruct the flow of feed fluid to the exchange device accumulates. The separator insert can have an inlet and an outlet, or form a passage, that provide fluid communication between the inside of the housing where separated fluid accumulates and the vent outlet where the separated fluid can be removed from the housing.

One embodiment of the present invention is a separator that can be inserted or secured into the vent portion of a housing. The housing may further include a porous membrane or exchange device, for treating process fluid that is mounted to the manifold of the housing. The porous membrane or exchange device can be non-dewetting or be treated to have a non-dewetting surface. The separator may have an inlet and an outlet or it can be made of a material capable of forming a shape that permits insertion of the separator into the vent and placement of the separator inlet in the housing at various positions within the housing, preferably a region of fluid velocity lower than at the inlet of the housing and even more preferably where the separated fluid accumulates in the housing. The inlet of the separator inside the housing permits the flow of the separated fluid, for example gas bubbles, out from the housing and through the vent.

In some embodiments a separator or deflector may be inserted or molded into the fluid inlet of the housing to direct fluid flow away from an inlet housing vent thereby reducing the fluid velocity in the vicinity of the vent. The separator, which can be a part of the vent, reduces fluid velocity near the vent and permits venting of a less dense fluid separated from the feed fluid, such as accumulated gases, from the housing through the vent. The separator in some embodiments can be an insert or form a part of the vent and may be used to deflect, reduce, or direct feed fluid flow from the housing inlet away from the vent and reduce fluid velocity in the vicinity of the vent inlet. The separator in other embodiments can form part of a flow path having an inlet and an outlet for removing separated fluid from the housing. The separator can deflect, reduce, or direct feed fluid flow away from the inlet of the separator flow path and reduce fluid velocity in the vicinity of the flow path inlet. The housing can optionally include a core vent that can vent a separated fluid from the core of an exchange device.

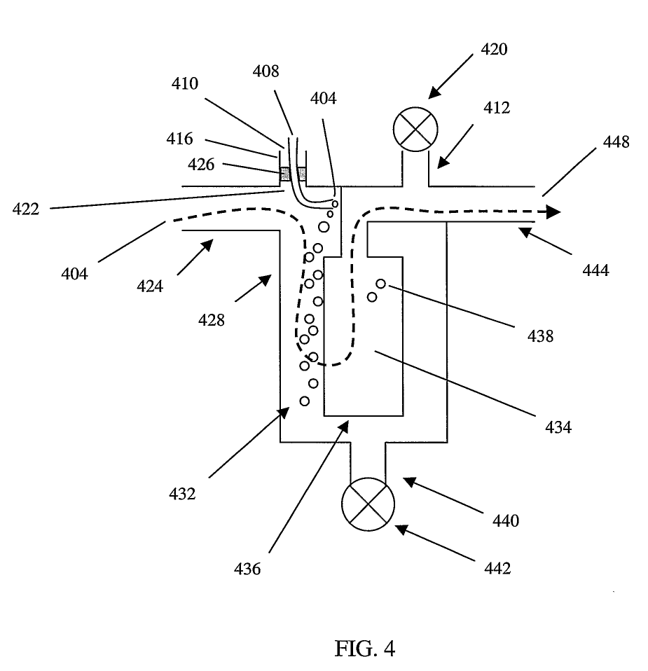

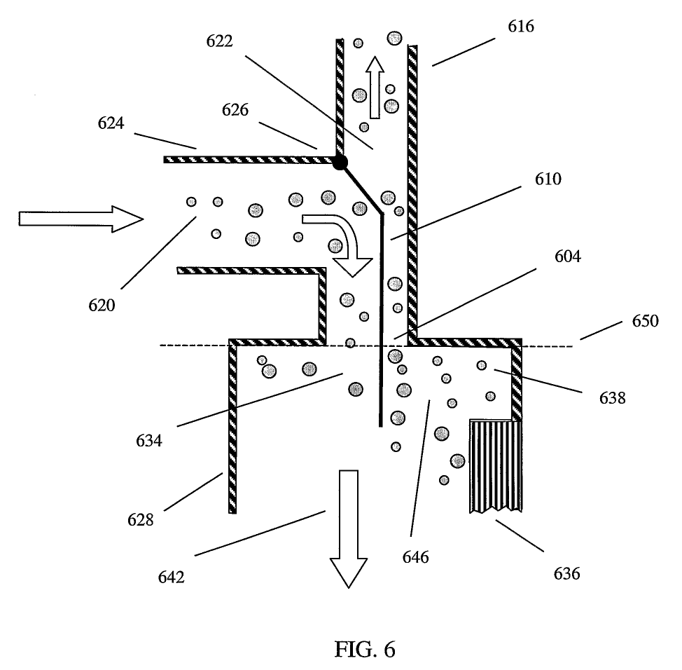

The separator within the housing provides a flow path from a low fluid velocity region inside the housing where a separated fluid from the feed fluid accumulates to the outside of the housing. The flow path can be in fluid communication with a feed side vent of the housing or manifold. The separator can be an insert, as shown for example by 410 in FIG. 4, that is placed in a vent of a housing, the insert provides an inlet in a region of the housing where the fluid velocity is less that the fluid velocity of a fluid inlet to the housing. The separator for the housing or manifold may be an insert, molded, press fit, bonded by welding or adhesive, machined, or otherwise fixtured to the housing or manifold. The separator in some embodiments protrudes below a surface or plane of the housing or manifold head, for example the separator 610 protrudes below plane of the feed fluid inlet illustrated by dashed line 650 in FIG. 6. In some embodiments, a separator is positioned between the fluid inlet and feed side vent, the separator forming a region in the housing where the fluid velocity is less than the fluid velocity inlet to the housing.

A separator can be installed in a housing and a flow of gas saturated liquid or a sparge of gas into a flowing liquid introduced through the feed fluid inlet of the housing containing a heat or mass exchange device. The sparge gas is a separated fluid mixed with the flowing liquid. Fluids that separate from the feed fluid can be less dense, more dense than the feed fluid. The separated fluid can be partially or completely insoluble in the feed fluid. In the case of an exchange device that is a porous membrane, the porous membrane wet by the feed fluid will not allow a separated fluid like a gas to displace feed fluid from the membrane. The differential pressure across the membrane can be monitored by pressure gauges on the fluid inlet and fluid outlet ports of the housing or manifold during fluid flow. The differential pressure can be measured with and without a separator in a region where a flow path formed by the separator allows gas (and optionally some feed fluid) that separates from the feed liquid to be removed from the housing. The differential pressure may be used to determine the best position or region for placement of the flow path for the separator in the housing. A lower differential pressure across the membrane with removal from the housing of separated gas from the liquid indicates a better region for the location of separator flow path inlet. The inlet of the separator may include a hydrophobic, lyophobic, or super hydrophobic material, which can be a membrane, that allows accumulated gas or other separated fluid to pass through the separator inlet but prevents liquids that do not wet the material from passing into the separator flow path.

Various housing configurations can be used with the separator. In one module design, liquid to be filtered, treated, flows from one end of the filtration module through the membrane and to the other end of the module. In this class of the filtration modules, the feed, vent, and permeate outlet connections are located at opposite ends of the exchange device or filter housing, thereby forcing the liquid flow to move from one end to the other. This flow configuration is referred to as an in line flow configuration. Another housing for an exchange device or filtration modular design locates all of the connections at the same end of the module. In this type of module, the feed and permeate ports are typically horizontally oriented at the top or “head” end of the module on opposite sides. Due to their shape, these modules are referred to as having a T, L or U configuration. This configuration facilitates connection of the head to the remaining portion of module comprising the bowl and fluid conditioning structure, for example a filtration cartridge, positioned within the bowl. In this design, the bowl and fluid conditioning structure, such as a filtration and or purification cartridge, can comprise separate elements or they may be bonded together to form a disposable unit having a unitary structure. When using a module with separate components, the filtration and or purification cartridge and the bowl are separately secured to and sealed to the manifold head. In addition, upon completion of energy exchange, filtration and or purification, the bowl and cartridge are separately removed from the head. This separate removal involves moving the bowl a distance substantially greater than the entire length of the cartridge in order to expose the fluid conditioning cartridge to permit its removal. Thereafter, the exposed cartridge is removed by hand or with a hand tool. Since the cartridge can be saturated with the liquid being treated, which is often times corrosive or toxic, the cartridge removal step presents a danger to the worker. To remove the fluid conditioning cartridge, the bowl can be moved the length of the cartridge to accomplish this removal step. Disposable units may be removed as a single unit and contain fluid remaining in the housing.

A housing for an exchange device or a fluid conditioning structure such as a filter cartridge, can be formed from a manifold and a bowl. The manifold, bowl, and exchange device may be bonded to one another to form a disposable device. The bowl bonded to the manifold can form the housing for the exchange device and the exchange device can be bonded to the manifold in a manner which prevents mixing of a fluid feed to the housing module and a treated fluid or permeate fluid removed from the housing module. Alternatively, the manifold, bowl, and exchange device or conditioning structure may be reversibly joined and separated from one another using o-ring, gasket, thread, or other similar seals to form a reusable housing, the manifold and bowl forming the housing. The bowl can be removed from the manifold with the manifold connected to other conduits, valves, or a dispense nozzle; the exchange device and bowl are fixtured with the manifold in a manner which prevents mixing of a fluid feed to the module and a treated or permeate fluid removed from the module. A separator can be positioned in a vent or other port the manifold or the housing or it can be molded as part of the housing or manifold.

Various methods and devices can be used to secure the cartridge to the housing, whether they be lugs, bayonets or wings, o-rings, welding or fusion bonding, mated threads, or other means, and may be mounted to any portion of the cartridge.

The housing or manifold, bowl, and portions of the fluid conditioning structure such as the porous membrane support structures including core, cage, and endcaps may be made of ceramic materials, metals, a polymeric material, or a composite containing any of these. In embodiments, the bowl and housing or manifold can be chemically and thermally stable thermoplastic including polyolefins such as polyethylene, ultrahigh molecular weight polyethylene or polypropylene, copolymers or terpolymers of polyolefins, nylons, PTFE resin, PFA, PVDF, ECTFE and other fluorinated resins, particularly perfluorinated thermoplastic resins, polycarbonates, polysulphones, modified polysulphones such as polyethersulphone, polyarylsulphones or polyphenylsulphones, any glass or other reinforced plastic or a metal such as stainless steel, aluminum, copper, bronze, brass, nickel, chromium or titanium or alloys or blends thereof.

The housing for the exchange device or fluid conditioning structure and the separator in the housing, may be made from a variety of materials that are chemically compatible with the process and feed fluid to be treated. Materials may include metals, composites, or plastics. In some embodiments, the housing or components such as a manifold, a bowl, a separator, a fluid conditioning structure can be made from a thermoplastic or similar material that can be molded. In some embodiments the housing components have an axis or plane of symmetry. In other embodiments, the housing or components such as a manifold head and bowl for the exchange device can be made from a thermoplastic or similar material that can be molded and are asymmetric. Fluid conditioning structures include surfaces for treating the fluid by mass exchange including chemically or physically bonding contaminants in a fluid to the fluid conditioning structure. Fluid conditioning structures include treatment surfaces for heat exchange, mass exchange, filtration, purification or a combination of these. The treatment surfaces can include one or more hollow tubes, hollow fibers, porous membranes, cartridges, plates, or structures including these. The fluid conditioning structure can include separate elements from the housing, for example cartridges, or they may be bonded together with the housing to form a disposable unit having a unitary structure. In some embodiments, for example hollow fiber membranes, the housing can enclose a porous membrane with a portion of the membrane support or potting bonded to the housing. Where it is desirable to locate the position of a vent, such as the feed fluid vent, away from a line of symmetry for the housing, the mold used to make the housing may be asymmetric and the vent located in a region where fluid velocity is reduced from the fluid inlet fluid velocity and where separated fluid, such as gas, can accumulate. Alternatively an insert, such as that shown by 410 in the non-limiting example of FIG. 4, can be placed in the vent. The insert can be positioned so that an inlet to the insert is positioned to a region of the housing where separated fluid accumulates during use.

For an exchange device or fluid conditioning structure that is a filter, the selection of filtration media used within the filtration cartridge can be any of those commonly used in the industry or can be any of those commonly used that are non-dewetting. Typically, the media includes, but are not limited to, flat sheet membrane, spiral wound flat sheet membrane, pleated flat sheet membrane, spiral pleated flat sheet membrane, hollow fiber membrane, sintered metal filter media, ceramic media, particulate media containing an active capture material such as resin or ceramic beads or a membrane with ligands for removing selected materials from the fluid attached to the resin or bead surfaces, ion exchange media such as anion resin, cation resin or mixtures of the two alone or incorporated into a membrane structure and combinations of any of these. The filtration media may be formed of any material typically used in filtration such as paper, other cellulosic materials such as regenerated cellulose or nitrocellulose, glass fiber and fabric, metal such as stainless steel, nickel, chromium and alloys and blends thereof, ceramics, plastics, preferably thermoplastic materials such as polyolefins, homopolymers, copolymers or terpolymers, including polyethylene such as ultrahigh molecular weight polyethylene, polypropylene and the like, PVDF, PTFE resin, PFA, ECTFE and other fluorinated resins, particularly perfluorinated thermoplastic resins, PVC, nylons, polyamides, polysulphones, modified polysulphones such as polyethersulphones, polyarylsulphones and polyphenylsulphones, polyimides, polycarbonates, PET and the like. In some embodiments, the material used for the filtration media may be chosen so that the porous membrane can be wet by the feed fluid or will not allow feed fluid in the membrane to be displaced by a separated fluid (non-dewetting).

A variety of coatings or surface treatments may be used to make fluid conditioning surfaces, for example porous membranes, with a modified surface energy that are non-dewetting or are spontaneously wet by a feed fluid. Non-dewetting porous membranes can include but are not limited to those disclosed in U.S. patent application Ser. No. 08/848,809, filed May 1, 1997, which is incorporated herein by reference, and provides a process for modifying a surface of a porous membrane such as a polyperfluorocarbon membrane with a bound perfluorocarbon copolymer composition that can render the entire surface non-dewetting. Other non-limiting examples of membranes with useful coatings are disclosed in U.S. Pat. No. 6,179,132 the contents of which is incorporated herein by reference in its entirety. In some embodiments porous membranes of these materials may have their surface modified with a perfluorocarbon polymer composition or other functional groups so that the modified surface is directly wet with a feed fluid, and preferably a feed fluid that is an aqueous liquid. The coverage of the membrane with surface modification can be determined by staining with Methylene Blue dye. In some embodiments the membrane is stable and remains non-dewetting during use at temperatures of up to about 140° C., in some embodiments from about 50° C. to about 140° C., and in other embodiments the membrane is stable and remains non-dewetting during use at temperatures at or above about 180° C. Similar treatments can be used to modify the surface energy of other fluid conditioning surfaces including but not limited to hollow fiber porous membranes, or hollow tube that are skinned or unskinned.

When modifying a porous membrane surface with a surface modification, the porosity of the membrane can be retained. Thus, sufficient surface modifying composition can be applied to effect the desired modification without substantially plugging the pores of the membrane substrate. Thus, the membrane having its surface modified should retain sufficient porosity to permit its use as a filtration and or purification membrane. An intermediate amount of surface modifying compositions can be applied to a membrane substrate and therefore differ from coating a solid substrate such as films, powders or fibers.

The fluid conditioning structure or exchange device includes surfaces for treating the process fluid in the apparatus and may be a porous membrane which can be used for removal of impurities from the feed fluid flowing into the device. Examples of impurities that can be removed from the feed fluid by the membrane include but are not limited to particles, molecular contaminants, gels, colloidals. and combinations of these. The impurities may be dissolved or suspended in the feed fluid. The feed fluid may also include additional fluid phases such as gases and liquids which may or may not be dissolved or miscible with the feed fluid. Alternatively, the surface for treating the process fluid may exchange heat or mass with the process fluid. Examples of heat and mass exchange devices that may include a separator include devices that heat liquids with thin walled hollow tubes, liquid to liquid contactors, cross flow filtration devices, or a combination of these.

The porous membrane used in the separation device or treatment apparatus may have pore sizes suitable for filtration of various sized particles including but not limited to hard particles, gels, bacteria, and colloids. The membrane may be a microporous membrane with pores and or a surface coating capable of removing particles of about 20 microns or less, more preferably particles less than about 1 micron, and even more preferably less than 0.1 micron. The porous membrane can also be coated with chemically reactive groups to remove molecular contaminants from a feed fluid.

The outer or inner surface of the treatment surface in the apparatus can be skinned or unskinned. A skin is a thin dense surface layer integral with the substructure of the membrane. In skinned membranes, the major portion of resistance to fluid flow through the membrane resides in the thin skin. The surface skin may contain pores leading to the continuous porous structure of the substructure, or may be a non-porous integral film-like surface. In porous skinned membranes, permeation occurs primarily by connective flow through the pores. Asymmetric refers to the uniformity of the pore size across the thickness of the membrane; for hollow fibers, this is the porous wall of the fiber. Asymmetric membranes have a structure in which the pore size is a function of location through the cross-section, section, typically, gradually increasing in size in traversing from one surface to the opposing surface. Another manner of defining asymmetry is the ratio of pore sizes on one surface to those on the opposite surface. In heat exchange devices, the treatment surface may be non-porous, skinned, or porous.

Fluidly sealed includes potting resin that has either been fused with a thermoplastic member, a membrane, hollow tubes, or hollow fibers or has formed a mechanical bond with the membrane by entering and wetting the pores of the fiber with the thermoplastic. The seal is characterized in that fluid does not flow past the membrane in the potted area, rather fluid flows through inside of the membrane, in the case of porous fiber, or is confined to the inside of the hollow tubing and is physically separated from fluid on the outside of the hollow tubing or fiber. Filter cartridges, hollow fibers, hollow tubes, separators or combinations of these may be fluidly sealed to the housing or manifold.

Bonding of the housing and membranes, thermoplastic members, thermoplastic hollow tubes, and or other device elements in a filtration, purification or contacting device may include physical mixing of melted materials as during welding or fusion of thermoplastics, adhesives, mechanical interlocking of material, fluid and compression fittings (such as but not limited to barbs, Swagelock®, Flaretek®, and Pillar) as well as chemical bonding of the materials. Preferably the bond between the housing and optional vent insertion device and provides a fluid tight seal with the housing sufficient for the intended use of the separation device. Hollow fiber contactors or exchanges may be made using methods known in the art and in particular those disclosed in U.S. Patent Application Publication No. 20030912428 the disclosure of which is incorporated herein by reference in its entirety.

Housing or manifold fluid inlet, fluid outlet, and vent ports may have fittings or connectors, for example Flaretek®, Pillar, Super Pillar, Flowell, Swagelock® and others, tube ends for welding, threaded or tapped conduits and flanges, gasket or o-ring seals, compression fittings, barbs, or any combination of these for connecting the housing or manifold to other devices and conduits.

A fluid that separates from the feed fluid can include gases, liquids, solids suspended in a liquid, combinations of these, or other separated phases. The separated fluid has a density that differs from the feed fluid. In some embodiments the density of the separated fluid is less than the feed fluid.

The flow of fluid into the housing can result in flow velocities that inhibit or prevent the removal of separated fluid from the housing. Fluid velocities for example can be 12 cm/sec or more, and as high as 150 cm/sec or more at positions within the housing such as the inlet of the housing or a vent of the housing. The fluid velocities depend upon the inlet fluid flow and the surface are of the inlet or vent. The flow of fluid may be continuous or pulsed as in a dispense of fluid. Without limitation, fluid flow may be greater than 1 liter per minute, or greater than 10 liters per minute through the porous membrane or along an exchange contactor surface. The location of a vent in the housing, the location of the inlet of a separator or insert placed into a housing vent, or a passage formed by a separator or insert with the vent can be in a region of the housing where the fluid velocity is less than 150 cm/sec or less, and in some embodiment located in a region where the fluid velocity is 12 cm/sec or less. One embodiment includes positioning a port or flow path to vent a separated fluid from a housing, the port or flow path located in a region of low fluid velocity in the housing. The position of the port or flow path can be where bubbles can rise against the feed fluid flow. A region of the housing, for example a portion of the annular region of the manifold, where a fluid separates from the feed fluid and accumulates, can have lower fluid velocity than the inlet feed fluid velocity.

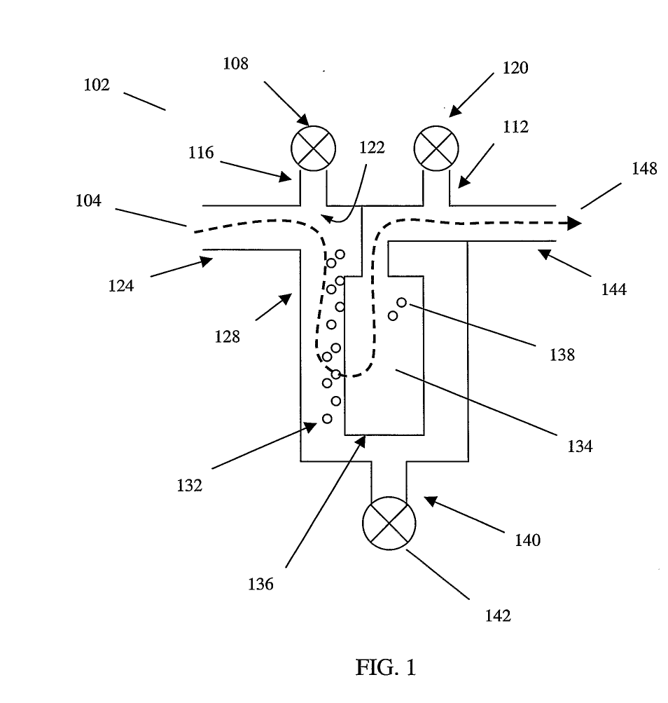

As illustrated in FIG. 1, a housing 128 can have a fluid inlet or feed fluid inlet 124 and a treated fluid outlet or permeate fluid outlet 144 for connection of the housing into a fluid flow circuit. A fluid 104 that enters the housing inlet 124, can pass through a porous membrane or other fluid conditioning structure 136 where contaminants are removed, and flows as permeate fluid 148 through the outlet 144. The housing has a vent 116 on the outside, or feed side, of the fluid conditioning structure 136, and may have an outlet vent 112 in fluid communication with the treated fluid (permeate) which can be the core of a membrane filter. These housing vents 116 and 112 may be connected to optional valves 108 and 120 respectively, optionally the housing or bowl may have a drain 140 that can be further connected to an optional valve 142. As illustrated in FIG. 1, fluid 104 that enters the housing through the inlet 124, can be distributed around the outside of the membrane 136 which is in the fluid flow path between the inlet 124 and outlet 144 of the housing. As illustrated by the dashed arrow, feed fluid flows through the fluid conditioning structure 136 where particles, contaminants, or a combination of these are retained by the membrane surface (pores, reactive functional groups, adsorption with membrane surface). Purified fluid, permeate, can enter the core 134 of the membrane and can be removed from the housing through a fluid outlet 144. A less dense fluid phase such as a dissolved gas which passes through the membrane and separates from the main fluid 138, for example due to a pressure drop, may accumulate in the core of the membrane module and can be vented through the core vent 112. A fluid phase 132 such as a dissolved gas that cannot pass or is inhibited from passing through a non-dewetting membrane may accumulate on the outside of the porous membrane 136. As illustrated, a region 122 of high fluid velocity can exist near the inlet to the feed side vent port 116 and can inhibit or prevent removal of the separated fluid 132 from the housing or bowl 128.

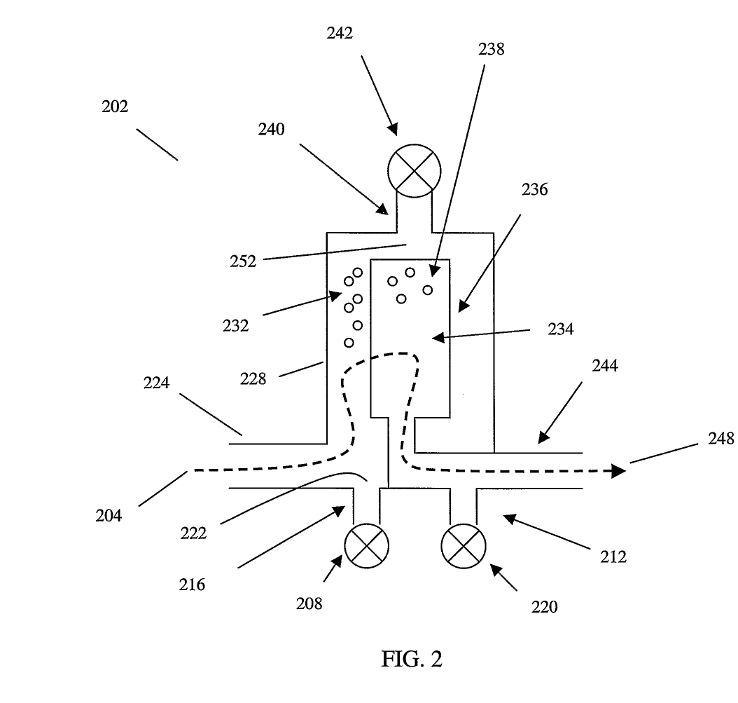

A bowl up configuration, is illustrated in FIG. 2, the apparatus housing 228 has a fluid inlet or feed fluid inlet 224 and a fluid outlet or permeate fluid outlet 244 for connection of the housing into a fluid flow circuit. A fluid 204 that enters the housing inlet 224, can pass through a porous membrane 236 where contaminants are removed, and then flow as permeate fluid 248 out to the outlet 244 and back into a fluid flow circuit or a process tank. The housing or manifold portion can have a vent port 216 on the outside of the membrane, feed side, which in a bowl up configuration acts as a drain for fluid 204 but cannot vent a separated fluid 232 that accumulates in the housing. The housing or head portion and may have another vent port 212 in fluid communication with the core of the membrane (permeate) that can act as a drain for fluid 248, but in a bowl up configuration cannot be used to directly vent a less dense fluid 238 that has separated, for example due to a pressure drop across the membrane, in the core 234. These housing vents may be connected to optional valves 208 and 220. In the bowl up configuration, the housing or bowl 228 may have a drain 240 connected to an optional valve 242 that can be used to vent a fluid 232 that has separated from the feed fluid 204. As illustrated in FIG. 2, fluid 204 that enters the housing through the inlet 224, can be distributed around the outside of the membrane 236 which is in the fluid flow path between the inlet 224 and outlet 244 of the housing. As illustrated by the dashed arrow, feed fluid flows through the membrane 236 where particles, contaminants, or a combination of these are retained by the membrane surface (pores, reactive functional groups, adsorption with membrane surface). Purified fluid, permeate, enters the core 234 of the membrane and is removed from the housing through a fluid outlet 244. A less dense fluid phase such as a dissolved gas which passes through the membrane and separates from the main fluid 238, for example due to a pressure drop, may accumulate in the core 234 of the membrane module. A fluid phase 232 such as a dissolved gas that cannot pass or is inhibited from passing through the membrane may accumulate on the outside of the porous membrane 236. A region 252 of low fluid velocity near the inlet to the housing vent 240 could be used for removal of the separated fluid 232 from the housing or bowl 228, however the housing does not include a vent that can remove separated fluid 238 from the treated fluid 248 in the core of the membrane.

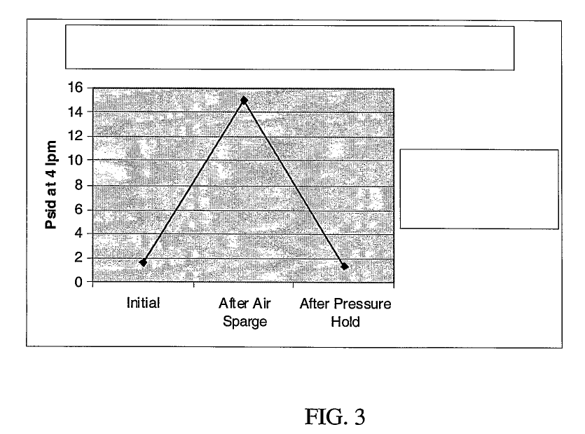

FIG. 3 illustrates the effect of separated gas on pressure drop for a liquid that flows through a porous membrane, the membrane is non-dewetting and inhibits gas flow through the membrane. In an apparatus as illustrated in FIG. 1, which includes a core vent, a pressure drop across the membrane with a flow of feed fluid without separation of a gas has a differential pressure drop represented by the point “Initial” in FIG. 3. Air introduced into the feed fluid inlet to simulate outgassing of the flowing feed fluid results in a reduction of available membrane for flow of fluid and an increase in differential pressure is observed as represented by the point labeled “After Air Sparge” in FIG. 3. The feed fluid flow can be stopped, accumulated gas vented, and the feed fluid flow resumed. The differential pressure across the membrane is represented by the point “After Pressure Hold”. This illustrates the effect that separated gas can have on differential pressure across a non-dewetting membrane in a housing in a bowl down configuration where the core of the device has a core vent, and where the manifold has an axis or plane of symmetry.

In an embodiment of the invention illustrated in FIG. 4, a housing 428 has a fluid inlet or feed fluid inlet 424 and a treated fluid outlet or permeate fluid outlet 444 for connection of the housing into a fluid flow circuit or to dispense treated fluid to a substrate, process tank or the like. The housing may also be formed or assembled from a separate manifold, fluid conditioning structure, and a bowl (not shown) as would be known to one skilled in the art. The housing 428 with a fluid conditioning structure, which can be porous membrane filter 436, is illustrated in the “bowl-down” position. By positioning a separator 410 in the housing, the inlet location of the vent port 416 can be changed from a high velocity region 422 to one of relatively lower fluid velocity 404. Using the separator 410 as illustrated in FIG. 4, for example a tube insert, the inlet to the vent port can effectively be placed somewhere in the annular portion of the housing away from the vent port location 422. The fluid velocity in the annular region can be lower than at the vent, allowing separated fluid 432 to accumulate and removed from the housing through separator outlet 408. The outlet 408 of the separator 410 may be connected to a valve or weir of an overflow tank or additional conduit (not shown). The separator 410 can be positioned in the vent 416 with an optional insert 426. A less dense fluid phase 438 that separates from the feed fluid 404 in the core 434, can be vented through vent 412 having optional valve 420. Permeate fluid 448 can be removed from the housing and filter core at permeate fluid outlet 444. The housing can have an optional drain 440 and drain valve 442. The housing may have a unitary structure where the housing is a single structure, or the housing may include a separable bowl, a filter cartridge, and a manifold.

Another embodiment of the invention can be an apparatus that can include a housing having a feed fluid inlet 424, a non-dewetting porous membrane in the housing 436, and a fluid outlet 444. The non-dewetting porous membrane 436 has a feed side that contacts the feed fluid and an outlet side that contacts the treated fluid. The housing 428 and the non-dewetting porous membrane 436 connected in a manner which prevents mixing of a feed fluid 404 inlet to the housing and treated fluid from the non-dewetting porous membrane in the region of 434 that is removed from the housing through the fluid outlet 444. The housing can further include a feed side vent 416 in fluid communication with the feed fluid inlet 424, an outlet vent 412 capable of removing a separated fluid 438 from the treated fluid 448, and a separator such as 410 in fluid communication with feed fluid on the feed side of the non-dewetting porous membrane. The separator forms a flow path with an inlet 404 in a region of the housing where a separated fluid 432 accumulates and an outlet 408 used to remove separated fluid from the housing 428.

A method to remove separated fluid that accumulates on the feed side of a fluid conditioning structure 436 can include the act of contacting a feed fluid 404 with a fluid conditioning structure 436 in a housing 428. The fluid conditioning structure 436 has a feed side that contacts the feed fluid and an outlet side that contacts the treated fluid. The housing 428 can include a fluid inlet 424 and a fluid outlet 444, the housing 428 and the fluid conditioning structure 436 connected or fixtured together in a manner which prevents mixing of the feed fluid 404 inlet to the housing at 424 and fluid treated 448 by the fluid conditioning structure 436 removed from the housing through the fluid outlet 444. The housing can further include an outlet vent to remove a separated fluid from the treated fluid. The method can further include the act of removing separated fluid 432 that has accumulated in the housing 428 on the feed side of the fluid conditioning structure with a separator like 410 that provides a flow path from a region of the housing where the separated fluid from the feed fluid accumulates 404, to the outside of the housing 408.

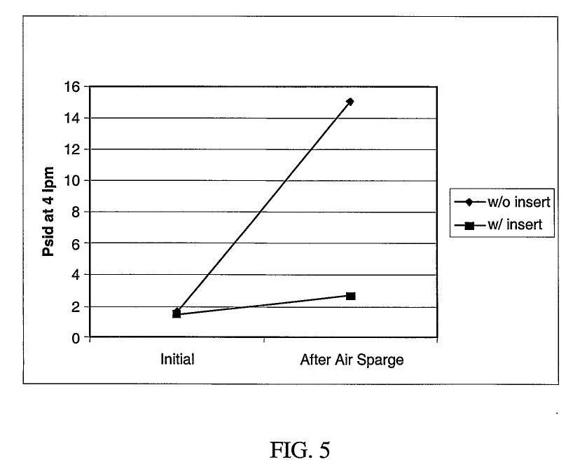

FIG. 5 compares the differential pressure drop across a porous membrane fluid conditioning structure in air sparging tests with and without a separator, such as 410, in place. As can be seen from the data, the differential pressure across the membrane increases sharply from about 2 psid to about 15 psid without the separator, while the differential pressure across the membrane stays at about 2 psid with the separator present. The lower pressure drop with the separator insert 410 in the inlet vent 416 of the housing illustrates that the bubbles can more easily escape the housing with the separator 410 because the effective inlet of the vent is now the separator insert tube inlet which is in a region like 404 of low fluid velocity rather than 422. Placement of the separator insert 410 into other areas or regions of the housing 428 may also provide a flow path from a low fluid velocity portion of the housing where a separated fluid 432 accumulates to the feed side vent.

FIG. 6 is an illustration of an embodiment of a separator 610 that has been bonded, molded, or otherwise fastened to a portion 626 of a housing or manifold head 628. The separator 610 can modify the position of the of the opening 622 of vent 616 from near the feed fluid inlet 624 to a separator opening 604 in a lower fluid velocity region 646 of the housing. Trapped gas or other separated fluid 638 can lead to loss of effective filtration or contactor area of fluid conditioning structure 636 due to accumulating separates fluid like a gas 638. Feed fluid 620 enters the housing in region 634. Separated gas 638 optionally with minor amounts of feed fluid 620 can be removed from the inside of the housing through the flow path opening 604 formed by the separator 610 and vent 616. By removing separated fluid 638 from the housing, a fluid 642 with reduced amounts of separated fluid can be treated with the conditioner 636.

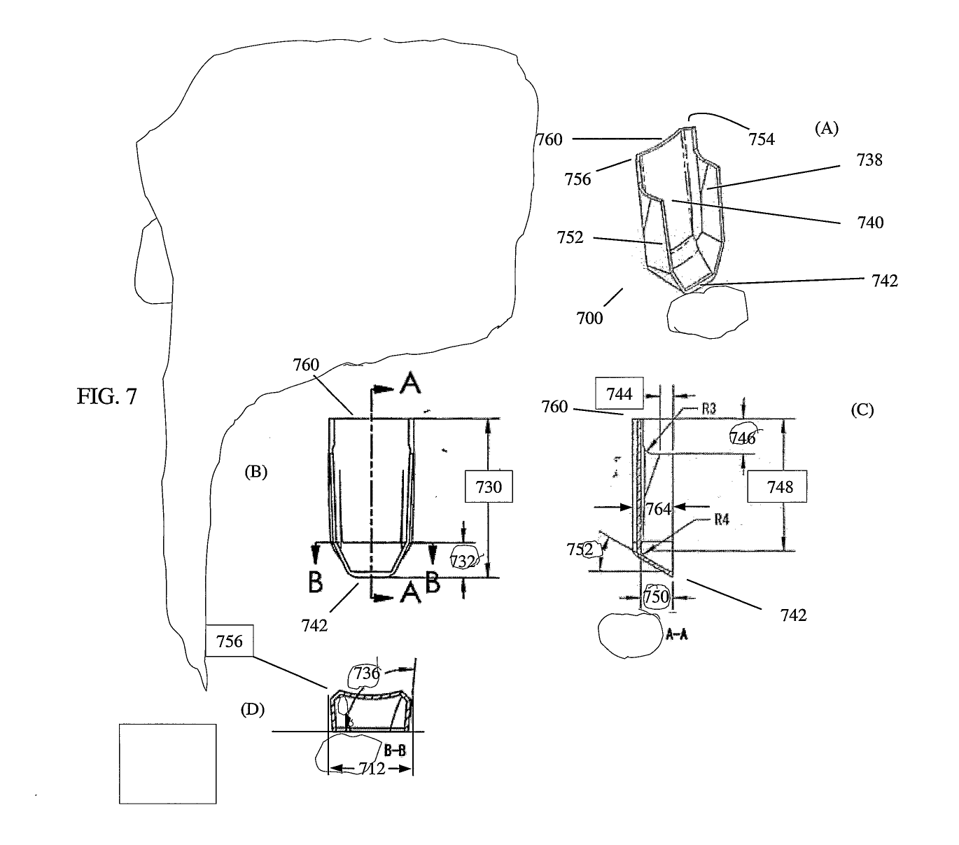

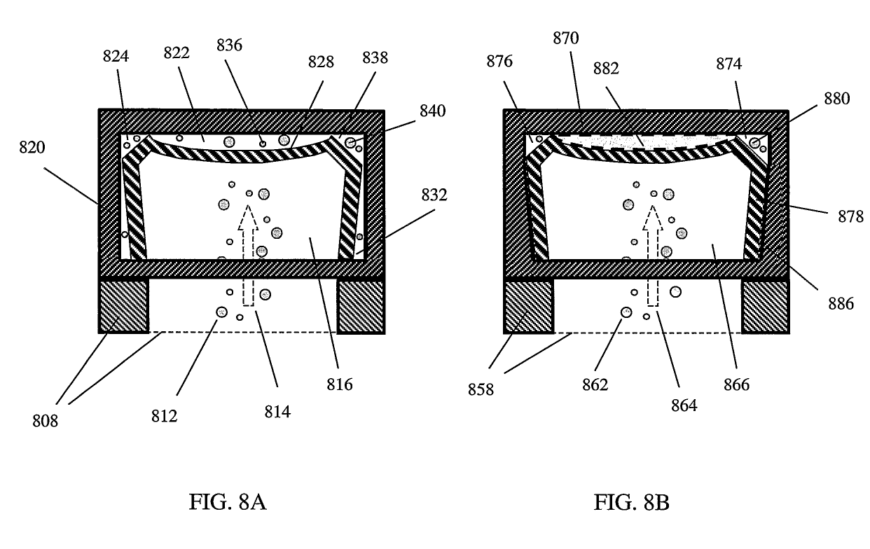

FIG. 7(A-D) illustrate various aspects of a non-limiting example of an separator 700 that can be fastened or fixtured to a housing by press fitting, welding, bonding, or otherwise securing the separator to the housing. Alternatively, a separator with similar features could be molded into a housing or manifold. In the top down view of FIG. 8B, a separator is shown inside of a vent, channel, or port 870 in a housing. As illustrated in FIG. 8B, the separator can be used to form one or more fluid flow paths from a region of low fluid velocity in the housing, for example 874 and 876, that can be used to vent a separated, less dense fluid 880, from the housing. The separator can be any shape that provides a flow path from a region in the housing where separated fluid accumulates to the outside of the housing where the separated fluid is removed. In one embodiment, the separator provides a flow path from a region in the housing where separated fluid accumulates that has lower fluid velocity than the feed inlet fluid velocity; the flow path formed by the separator is in fluid communication with the outside of the housing where the separated fluid can be removed. In another embodiment, the separator includes a conduit that is in fluid communication with a region in the housing where separated fluid accumulates and the outside of the housing where the separated fluid can be removed. The separator can form a flow path 876 from surfaces of the separator 878 and housing channel 870. The separator can be shaped to direct fluid away from a vent and reduce fluid velocity in a region near the vent. The separator can be made to fit into any shaped vent or channel, and provide a flow path with the housing.

FIG. 7A is a perspective view of a non-limiting illustration of a separator 700 that can placed into a vent or other housing conduit for removing separated fluid from a housing. The edge 742 can be shaped to mate with a vent surface, a channel, manifold head surface, or housing surface and can be used to divert feed fluid away from the vent and or support the separator. The feed fluid can be directed by one or more surfaces of the separator to reduce feed fluid velocity at a vent opening. These surfaces may include concave, convex, planar shapes and combinations of these. A non-limiting example of a separator with these types of surfaces is shown by surfaces 738, 740 and 752 of the separator 700 in FIG. 7A. Surfaces like 754 and 756, are non-limiting examples of separator surfaces that can be used to form a flow path for separated fluid to be removed from the housing. A portion of the shape of surface 740 is illustrated by edge 760, surface 740 can be used to form a flow path or may be used to contact a housing surface for added support.

The separator occupies a space in a housing or manifold related its length and cross section. The space occupied by the separator and surface area where it contacts the housing or a channel in the housing may be changed to modify the number and size of flow paths, the location of the flow path inlets in the housing or manifold, the bonding area of the separator, or combinations of these. For example, the separator 700 would occupy a space determined by 712, 730, and 764. These may be adjusted without limitation to provide a flow path for the separator and to reduce fluid velocity at a vent opening. Other aspects of a separator, for example surfaces that interact with the feed fluid, surfaces that form a flow path for the separated fluid, or surfaces that form a region in the housing or manifold where separated fluid can accumulate, or combinations including any of these can also be modified. These can be surfaces defined by a radius, angle, or combination including these. For example, in the separator 700, contoured surfaces interacting with the feed fluid may include slope surfaces with angle 752, of height 732. In the separator 700, the region in the housing or manifold where separated fluid can accumulate may be modified by changing the size and shape of a feature described by height 746, depth 750, and length 748. The cross section profile of the separator, for example as illustrated by the non-limiting schematic FIG. 7D, can be modified along the length of the separator to vary the feed fluid flow path and the separated fluid flow path. Angles 736 between the side walls like 738 and front edge of the separator can be modified. The length, thickness, contour, angle, or any combination including these of surface 756 and or surface 760 of a separator like 700 could be modified to vary the feed fluid flow path and the separated fluid flow path. Similar modifications could be made for separators having other cross sectional profiles.

In the top down view of FIG. 8A, a separator is shown inside of a vent or channel in a housing or a manifold. The separator 828 can be secured to the housing or manifold vent channel 820 where feed fluid 814 including a separable fluid 812 enters a volume 816 of the separator 828 from the feed fluid inlet 808. The feed fluid is directed to other regions of the housing (flow into the page) that can include a fluid conditioning structure that exchanges heat or mass with the feed fluid 814. Flow paths within the separator or formed by a separator with portions of the housing can form one or more fluid flow paths 824 and 838 from a region of low fluid velocity in the housing to a vent or other channel 820 in the housing where the separated fluid can be removed from the housing. For example, separator 828 within the housing channel 820, can form for example flow paths 822, 824, 832, and 838, to provide a passage for separated fluid, or separated fluid and feed fluid to be removed from the housing or manifold head. For example separate fluid depicted by 836 and 840 flows out from the page through flow paths 822 and 838 respectively, and can be removed from the housing channel 820.

FIG. 8B illustrates a separator 878 that can form one or more fluid flow paths from a region of low fluid velocity in the housing, for example flow paths 874 and 876, that can be used to vent a separated, less dense fluid 880, from the housing. The separator 878 can be secured to the housing or manifold 870 vent where feed fluid 864 including a separable fluid 862 enters a volume 866 of the separator 878 from the feed fluid inlet 858. The feed fluid is directed to other regions of the housing, flow into the page, that can include a fluid conditioning structure that exchanges heat or mass with the feed fluid 864. Flow paths within the separator or formed by a separator with portions of the housing can form one or more fluid flow paths from a region of low fluid velocity in the housing to a vent or other port where the separated fluid can be removed from the housing. For example, separator 878 with the housing 870, can form for example flow paths 874, and 876 to provide a passage for separated fluid 880, or separated fluid and feed fluid to be removed from the housing or manifold head vent 870. For example separate fluid depicted by 880 flows out from the page, through the flow paths 874 where it can be removed from the housing or manifold vent opening 870. A portion of the separator 878 is illustrated touching housing or manifold 870 along 882, and another portion of the separator 878 contacts another portion of the housing or manifold 886. These areas of contact may be used to bond or fixture the separator 878 to the housing vent 870. In some embodiments the separator 878 may be molded during the molding of the manifold.

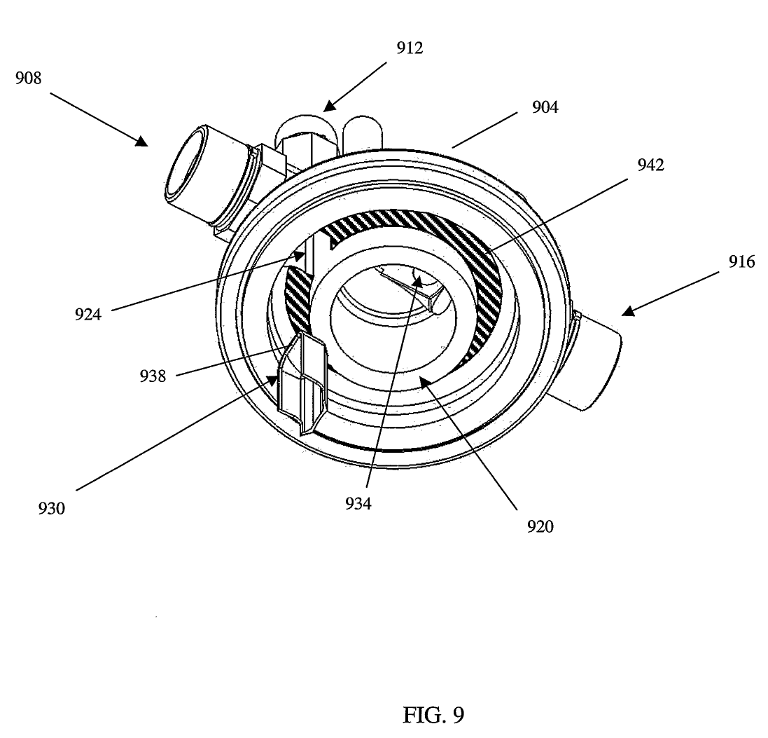

FIG. 9 shows a perspective view of a manifold 904, or portion of a housing, where a separator may be used. FIG. 9 illustrates a manifold 904 whose fluid inlet 908 fluid outlet 916 and inlet vent 912 and core vent 934 lie along a plane of symmetry. The manifold 904 may be bonded to bowl(not shown) to form a housing or the manifold may be provided with a joint that can be sealed to a bowl (or-ring, gasket, thread, or other) so that the bowl can be removed from the manifold with the manifold connected to a fluid flow circuit. The manifold 904 may have a fluid conditioning structure (not shown) bonded along flange 920, joined using o-rings, joined by structures described in U.S. Pat Appl. Pub. 2003/0141235 and incorporated herein by reference in its entirety, joined by threads, or joined by a compression fitting. The manifold or housing can have a feed fluid inlet 908, and a fluid outlet 916, a feed side vent 912 in fluid communication with the feed fluid inlet 908, a core vent 934 that can vent a separated fluid (less dense from the feed fluid) from the core of a fluid conditioning structure, a separator 930 that can be positioned within the housing to provides a flow path from a low fluid velocity portion of the housing where a separated fluid from the feed fluid accumulates, the flow path in fluid communication with the feed side vent. The inlet 924 of vent 912 is illustrated in the annular region 942, separator 930 is shown prior to insertion into inlet 924 of vent 912 and attachment to the manifold 904. When inserted into the vent, a top portion 938 of the separator 930 can be used to prevent feed fluid from fluid inlet from directly entering vent 912.

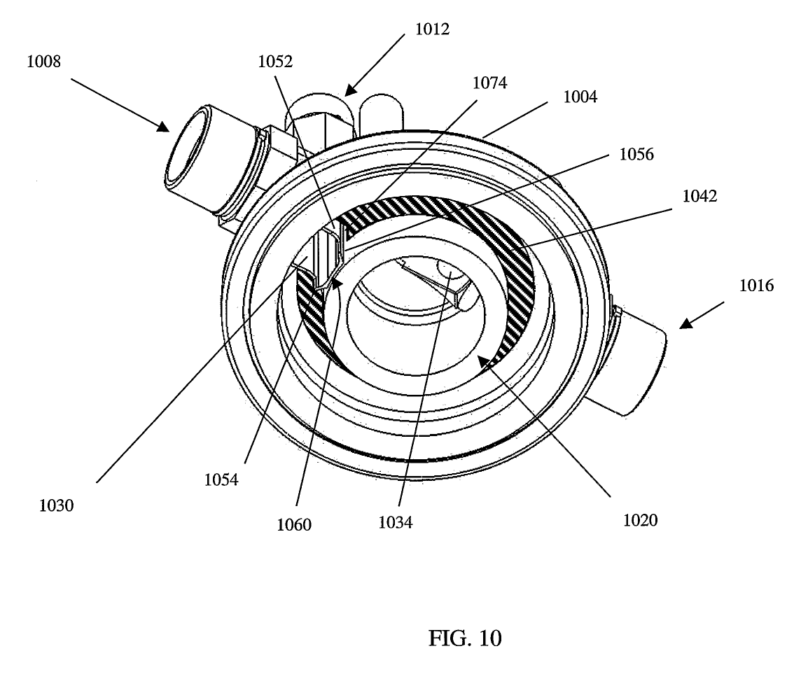

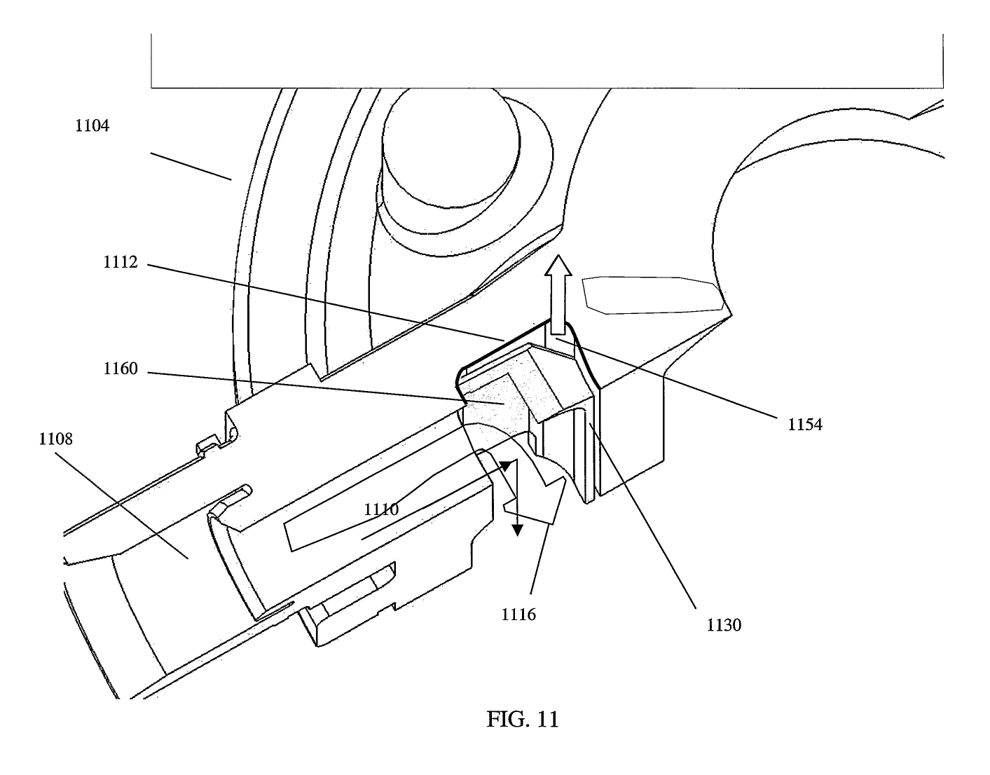

FIG. 10 illustrates a separator 1030 in the vent opening in the manifold of FIG. 9; the separator 1030 may be molded, bonded, or press fit to fasten it to the manifold 1004. Feed fluid can flow into the manifold 1004 at feed fluid inlet 1008 and along separator 1030 where it can enter the bowl or housing (not shown). The bowl or housing includes a fluid contacting structure that can be joined to the flange 1020, fluid passing through the contacting surface can flow through manifold outlet 1016. Separated fluid that accumulates in the treated fluid can be removed through vent 1034. The inside of the flange 1020 and the fluid outlet 1016 are in fluid communication with the outlet vent 1034. Surfaces 1054 and 1056 of separator 1030 can form one or more flow paths with the manifold 1004. For example, a flow path 1074 can be formed between surface 1056 of the separator 1030 and the housing in the annular region 1042. The inlet to the flow path 1074 is in a region of lower fluid velocity than the fluid velocity at the feed inlet 1008. The flow path is fluidly connected with inlet vent 1012 and can be used to remove separated fluid from the manifold or housing. Surface 1052 can be modified to change its height, width or other aspect along with other surfaces of the separator to form a low fluid velocity region near the flow paths for separated fluid to accumulated. An edge of the separator 1030 is shown contacting the flange 1020 at 1060. This contact may be used for bonding the separator 1030 the to flange 1020. FIG. 11 is a top down perspective view of a cut away portion of FIG. 10. FIG. 11 shows the manifold 1104 with a feed fluid inlet 1108, a portion of a vent or channel 1112 in the manifold, and a portion of an separator 1130 in the vent or channel 1112. The separator 1130 is positioned in the vent 1112 so that feed fluid flows along the separator and separated fluid can flow out of an opening 1112 in the manifold 1104. Feed fluid 1110 travels through the feed fluid inlet 1108, along the separator 1130, and down into the annular space and bowl through opening 1116. Feed fluid does not flow into the vent directly because the top portion of the separator, illustrated by shaded region 1160, (see also 938 in FIG. 9) directs fluid into the bowl. The separator forms one or more flow passages with the manifold channel, illustrated by 1154, between a region where separated fluid accumulates in the housing and the vent or channel opening 1112.

The housing may have a sloped surface surrounding vent, a flow path formed by the separator and housing to aid in the removal of separated fluid from the housing. For example, the annular region of a manifold may be sloped to aid in the transport of separated fluid into a flow path formed be a separator surface and a manifold channel. The insertion device may also have a sloped surface at its inlet located in the housing to aid in the removal of separated fluid from the housing.

Venting of gases or other separated fluids from the feed stream can be accomplished in a continuous or semi-continuous manner. In a semi-continuous vent gas is allowed to accumulate in the feed chamber, followed by venting the gas through port or vent. Venting can be timed. The venting can be automated so that a sensor detects the presence of accumulated fluid or feed fluid and signals a valve in fluid communication with a separator flow path to open and close. The sensor can be in the vent, a flow path of the separator, a sensor in the annular region of the housing or other position in the housing.

Embodiments of the present invention may be used in a apparatus to treat process fluids by removing contaminants from the fluid (particles or dissolved molecular or ionic contaminants), exchanging energy, or a combination of these. The apparatus may be used to dispense the treated process fluid or to recirculate it in a loop, closed or feed and bleed. The apparatus may also be used to treat the fluid via heat and or mass transfer (addition by chemical addition) with a process fluid. The apparatus may be connected to chemically compatible flow meters, flow controllers, pressure transducers, valves, temperature transducers, and fluid conditioners like in-line heaters of chillers. A chemically compatible pump can be used to flow or re-circulate process fluid with a tank optionally having an overflow basin. The pump, flow meters or other fluid conditioning, monitoring, and control equipment may be interconnected with a controller to manage the fluid conditioning and substrate processing. The overflow tank can include a serrated weir that overflows liquid into a catch basin for re-circulation into the main tank. Gas and liquid fluid line from the upstream and downstream vents of the filter apparatus can be feed into the catch basin of the overflow tank to remove separated gases and liquids vented from the housing, the vents may include valves. A chemically compatible in-line fluid temperature conditioner, for example one that incorporates thin walled thermoplastic surfaces, can be used to heat or cool a process fluid during re-circulation or for in-line temperature conditioning, The in-line fluid conditioner or heat exchanger may have fluid vents or inserts similar to those described in this specification to provide a low fluid velocity vent location for removing accumulated gases and maximizing contact area between the heater or chiller elements and the process fluid.

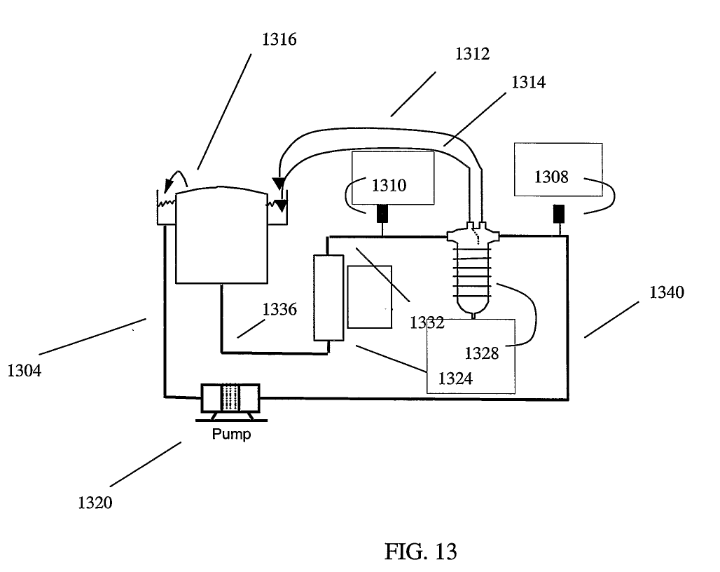

An non-limiting apparatus used to treat a process fluid and contact it with one or more substrates is illustrated in FIG. 13. The apparatus can include an overflow tank with weir and catch basin 1316 in fluid communication with a pump 1320. The pump directs process fluid from the conduit 1304 into the exchange device 1328. The exchange device includes a fluid conditioning structure where mass, heat, or a combination of these can be exchanged with the process fluid inlet to the exchange device through conduit 1340. The exchange device 1328 includes a separator that removes separated fluid from the process fluid that can be directed by vent line 1312 to the catch basin of the overflow tank 1316. The core of the exchange device 1328 also includes a vent that can be used to remove separated fluid from the treated process fluid. The separated fluid can be directed to the process tank catch basin through conduit 1314. The process fluid treated by the exchange device may be directed by conduit 1332 and or 1336 to the process tank or the fluid can be further treated by a heat exchanger 1324. The apparatus can include transducers to monitor properties of the process fluid or the state of the apparatus, for example pressure transducers 1310 and 1308 can be used to monitor the pressure drop across the exchange device 1328.

Various aspects of the present invention will be illustrated with reference to the following non-limiting examples.

### EXAMPLE 1

Many high temperature and chemically aggressive applications use PTFE (Teflon®) filters due to their excellent chemical compatibility. In some filtration applications these hydrophobic Teflon based membrane filters would experience partial dewetting in process applications which contained process fluid chemistries that would generate gas bubbles due to outgassing of the process fluid. Dewetting of the filter results in less available filtration area which decreases the lifetime and flowrate of the filter. Once dewet, the membranes need to be removed from the process and rewet with IPA resulting in decreased processing and generation of waste chemicals.

An example of a porous membrane that has been modified with a chemistry that does not allow the membrane to easily dewet in aqueous media, a non-dewetting membrane, is a modified porous polytetrafluoroethylene membrane included in Quick Change® filters available from the Mykrolis Corporation, Billerica, Mass. This surface modified membrane will not allow gas bubbles to pass through the membrane and the gas from the feed fluid can accumulate in the housing on the feed side of the filter. The gas in the housing can reduce the amount of liquid that passes through the membrane resulting in less flowrate through the filter.

In a housing that has an upstream vent located directly above the inlet fluid flow fitting, as illustrated in FIG. 1, the internal flow path can have a local high fluid velocity in this region. A high fluid velocity makes it difficult for gas bubbles to find their way up towards the vent. This phenomena is more prominent when the filter is run in the “bowl-down” position as shown in FIG. 1.

When the filter is run in the “bowl-up” position as shown in FIG. 2, the original “vent” is now a drain. The fitting now used to vent the filter is located such that there is a larger area for the flow path. The larger area results in a lower local fluid velocity. The lower velocity allows for the gas bubbles to move towards the vent port very easily and escape. A disadvantage of the bowl-up configuration is that it is not easy to vent the core of the membrane device because accumulating gases rise away from the vent and can become trapped by the core.

In a housing where the location of vent port is close to high fluid velocity it is very difficult for gases to escape the housing. Fluid flow annularly and though the filter creates a high local velocity. The high local velocity in a region of the feed vent port results in a negative pressure and gas can no longer escape easily as shown in FIG. 1.

A theoretical calculation can be made comparing the local velocities at the vent ports located in a typical symmetrical housing design. When the filter is run in the “bowl down” position, the calculation results show that a bubble of about 50,000 micron in diameter is required to rise at 20 lpm liquid flow at 1 g/cm3 density for a 1 cP fluid. This very large bubble cannot form readily. When the filter is run in the “bowl up” position, a bubble of about 500 micron in diameter is required to rise in annular portion of the filter under the same conditions. Therefore, it is easier for a smaller bubble to rise in the design where the vent is located in the annular area.

Closing a valve downstream of the filter (not shown) could be used to stop the flow rate through the filter. The bulk flow direction could then be changed towards the vent port. The liquid flow and gas bubble will now move up towards the vent port and the gas bubbles would escape housing along with the bulk liquid flow. However this does not allow uninterrupted operation of process and would require additional costs of valves.

An experiment was setup using a Chemline I QuickChange A TX filter with DI water under ambient conditions and having a downstream valve after the outlet of the filter device housing. The pressure drop across the filter was initially measured at 4 lpm feed fluid flow. The filter was then sparged with air on the upstream side at 15 psig for 10 seconds while the upstream vent remained open to simulate the separation of a gas from a feed liquid (similar to gas generation from a sulfuric acid and hydrogen peroxide mixture). The pressure drop was remeasured. Then the downstream valve was closed and the liquid flow changed direction towards the vent fitting which also allowed for the trapped gas to escape. The pressure drop was remeasured.

As illustrated in FIG. 3, the experiment showed that the filter's pressure drop drastically increased after the air sparge but then decreased back down to the initial pressure drop after the pressure hold when the downstream valve was closed and gas vented through the feed side vent.

When the filter is run in the “bowl-down” position, the location of the vent port can be changed, for example by inserting a separator that is a configurable tube into the vent. Using the configurable tube as illustrated in FIG. 4, for example, the vent port can be placed somewhere in the annular portion of the housing away from the vent port location. This can result in a larger surface area flow the liquid flow rate resulting a lower local velocity for the fluid which would allow for smaller bubbles to rise. As illustrated in FIG. 4, a fluid phase 432 such as a dissolved gas that cannot pass or is inhibited from passing through the membrane 436 may accumulate on the outside of the porous membrane and be vented through a separator such as a vent tube 410 or vent port located within the housing at a region near 404, the annular region where the separated fluid accumulates or a region near 404 in the housing having reduced fluid velocity compared to the inlet as illustrated in FIG. 4. Consider the case when liquid chemical is flowing at 20 lpm through the filter. The chemical would have a local velocity of about 150 cm/s at the vent port. But the same chemical flowing through the annular portion of the filter would have a velocity of about 12 cm/s. The lower velocity at the annular portion makes it easier for the gas bubble to rise up against the fluid velocity. A vent or flow path from a separator in the annular region could be used to remove separated fluid from the housing.

### EXAMPLE 2

The vent port can be moved to an area where the fluid velocity is lowered. Using a ⅜″ PFA standard wall tubing cut to 3.8 cm in length shows a mechanical example on how this idea is applied as illustrated in FIG. 4. A 10 cm ¼-inch PFA tube is put inside of the ⅜-inch tube and inserted into the upstream vent. This placement now puts the vent in the annular portion of the housing but more importantly away from the high velocity region of the vent port. Note that during the application, the outlet of this specified insert could be held in place by the Pillar insert on the vent and by the cartridge on the inside of the housing. FIG. 4 illustrates this mechanical example, however the housing could be modified or molded to provide a port at a location equivalent to that achieved by the inserted tube. Preferably such a housing could be made from molds which provide a symmetric housing, manifold, separator, or combination of these.

FIG. 5 shows the results comparing the air sparging test as detailed above with the insert in place. As can be seen from the data, the pressure drop does not rise nearly as much as without the insert. Therefore, the bubbles can more easily escape the housing because there is a larger area resulting in lower fluid velocity at the inlet of the insert tube. Placement of the insert into other areas of the housing may further reduce the pressure drop after the air sparge test.

In filtration and purification applications, it is desirable that the separation device housing, including a porous membrane or filter, have a design that places the vent port in an area of the housing where the fluid velocity is decreased to allow bubbles and other separated fluids and phases which do not pass through the porous membrane easily, to overcome the forces to rise up and vent the separate fluid efficiently.

The vent valve could include a sensor for detecting the presence of separated fluid and or feed fluid near a portion of the vent. A signal from the sensor, for example a capacitive proximity sensor indicating the presence a bubble or pocket of gas in or near the vent can be used to open and close the valve to vent the separated fluid (bubble) to a suitable container. This could be automated and interfaced to a process tool.

A porous membrane, including those with surface modifications to make them lyophilic to the feed fluid, hydrophilic in the case of an aqueous fluid, can restrict the passage of separated gases through the membrane and therefore accumulated gases (a fluid) can be difficult to vent. However, the surface modification does not allow the membrane to dewet and maximizes the available filtration area. By providing a separator with a flow path in the region of low fluid velocity to vent accumulated gases, processes can achieve better contaminant removal, for example particle removal and lifetime, while maintaining consistent flowrates. Process control of the systems can be increased.

### EXAMPLE 3

This example illustrates the improvement in flow for a re-circulating bath which generates gas and utilizes a filter having a porous membrane with a surface modification that does not allow the membrane to dewet and maximizes the available filtration area.

The reference filter apparatus was a non-dewetting 0.05 μm QuickChange ATM available from the Mykrolis Corporation, Billerica, Mass.; the modified filter apparatus was also a 0.05 μm QuickChange ATM with an insert show schematically in FIGS. 9-11.

A test bath is shown schematically in FIG. 13. Chemically compatible pressure transducers were in fluid communication with the inlet and outlet of the filter apparatus which allowed a differential pressure across the filter apparatus to be determined. The bath was a mixture of HCl:H₂O₂: deionized water in the approximate ratio of 1:1:5 and heated to 80° C. A chemically compatible pump was use to re-circulate the bath fluid into the tank (20 liters) and overflow (10 liters). As illustrated, an overflow tank can include a serrated weir that overflows liquid into a catch basin for re-circulation into the main tank. Gas and liquid fluid line from the upstream and downstream vents of the filter apparatus are feed into the catch basin of the overflow tank to remove gases and liquids vented from the filter housing. An chemically compatible in-line heater is used to heat the fluid during re-circulation.

After the filter apparatus was installed and the bath prepared, the pump was started. After about 1 minute the heater was turned on and heating continued until an elevated bath temperature of 80° C. was reached. The re-circulation and heating were maintained for 80 minutes.

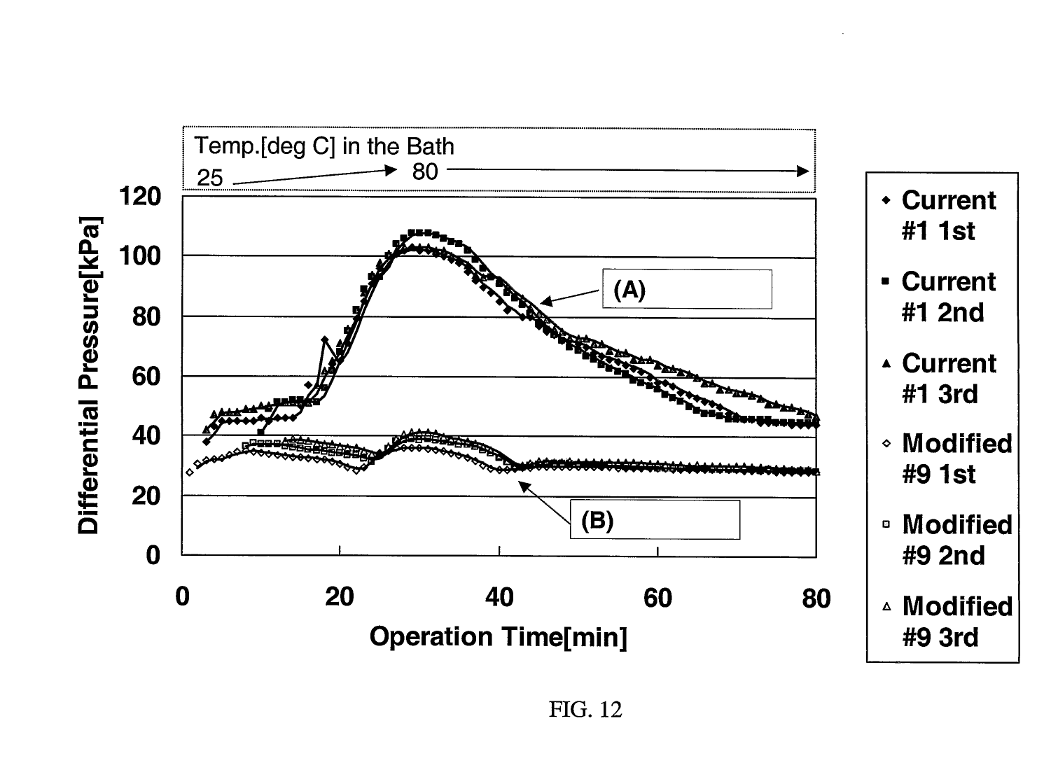

The bath generates oxygen due to decomposition of hydrogen peroxide during heating. For a filter apparatus an upstream vent positioned in a portion of the housing that does not facilitate gas venting, a region of high fluid velocity, the differential pressure across the filter apparatus rises (see FIG. 12A) after about 30 minutes indicating that gases generated by the bath block the filter from liquid fluid flow and reduces the available membrane surface area for filtration and contamination removal. For the same filter apparatus with an insert to lower fluid velocity near the vent, the differential pressure across the filter apparatus remains essentially constant throughout the heating and flow cycle (see FIG. 12B) indicating that generated gases can be removed at the upstream vent and returned back to the catch basin. The relatively constant differential pressure also demonstrates that the filtration area of the membrane is not blocked by accumulated gas.

The results show that reducing the fluid velocity in the vicinity of a vent enables better gas venting and maintains substantially uniform fluid flow through the porous membrane.

Although the present invention has been described in considerable detail with reference to certain preferred embodiments thereof, other versions are possible. Therefore the spirit and scope of the appended claims should not be limited to the description and the preferred versions contain within this specification.

What is claimed is:

1. An apparatus comprising:
a fluid conditioning structure in a housing, the housing comprises a fluid inlet and a fluid outlet, the fluid conditioning structure has a feed side and an outlet side, the housing and the fluid conditioning structure connected in a manner which prevents mixing of a feed fluid inlet to the housing and treated fluid from the fluid conditioning structure that is removed from the housing through the fluid outlet, the housing further comprises an outlet vent capable of removing a separated fluid from the treated fluid; and,
a vent to remove separated fluid that accumulates in the housing on the feed side of the fluid conditioning structure, the vent provides a flow path from a low fluid velocity region of the housing to the outside of the housing.

2. The apparatus of claim 1 wherein the vent further comprises a separator that forms a flow path from a low fluid velocity region of the housing to the outside of the housing.

3. The apparatus of claim 1 wherein the fluid conditioning structure comprises a thermoplastic porous membrane, the porous membrane characterized in that treated fluid in contact with the pores of the membrane is not displaced by a gas that separates from the feed fluid.

4. The apparatus of claim 1 wherein the housing includes a manifold and a detachable bowl, the manifold comprising a feed fluid inlet, a fluid outlet, a feed side vent, and a fitting for mounting a fluid conditioning structure.

5. The apparatus of claim 2 wherein the separator is positioned in a feed side vent and comprises an insert that modifies the position of the vent inlet to a region within the housing where the separated fluid accumulates.

6. The apparatus of claim 1 wherein the inlet of the vent is located in the annular region of the housing.

7. The apparatus of claim 1 where the vent is located in a region of the housing where the fluid velocity is below 150 cm/sec with an inlet feed fluid flow of 20 lpm into the housing.

8. The apparatus of claim 1 wherein the housing manifold has a plane of symmetry.

9. The apparatus of claim 2 where the separator provides a flow path from an annular region of the housing to a vent.

10. An article comprising:
an insert that is placed in a feed side vent of a housing that includes a fluid conditioning structure, the fluid conditioning structure connected to the manifold in a manner which prevents mixing of a fluid feed to the housing module and a treated fluid removed from the housing module, the insert provides an inlet in a region of the housing where a fluid that separates from the feed fluid accumulates and the insert provides an outlet for removing separated fluid from the housing.

11. The article of claim 10 where the insert has an inlet in the low fluid velocity region of the housing and an outlet in fluid communication with an housing vent.

12. The article of claim 10 where the insert forms a flow path with a portion of a housing vent, the inlet of the flow path in a region of the housing where the fluid velocity is less than the fluid inlet to the housing.

13. An apparatus comprising:
a housing having a feed fluid inlet, a non-dewetting porous membrane in the housing, and a fluid outlet, the non-dewetting porous membrane has a feed side and an outlet side, the housing and the non-dewetting porous membrane connected in a manner which prevents mixing of a feed fluid inlet to the housing and treated fluid from the non-dewetting porous membrane that is removed from the housing through the fluid outlet, the housing further comprises a feed side vent in fluid communication with the feed fluid inlet, an outlet vent capable of removing a separated fluid from the treated fluid; and
a vent in fluid communication with feed fluid on the feed side of the non-dewetting porous membrane, the vent forms a flow path with an inlet in a region in the housing where a separated fluid accumulates and an outlet to remove separated fluid from the housing.

14. The apparatus of claim 13 wherein the vent further comprises a separator that forms a flow path from a region of the housing where the separated fluid from the feed fluid accumulates to the outside of the housing.

15. The apparatus of claim 13 wherein the non-dewetting membrane further comprising a fluid at a temperature greater than 50° C.

16. A method comprising:
contacting a feed fluid with a fluid conditioning structure in a housing, the fluid conditioning structure has a feed side and an outlet side and the housing comprises a fluid inlet and a fluid outlet, the housing and the fluid conditioning structure connected in a manner which prevents mixing of the feed fluid inlet to the housing and fluid treated by the fluid conditioning structure removed from the housing through the fluid outlet, the housing further comprises an outlet vent to remove a separated fluid from the treated fluid; and,
removing separated fluid that has accumulated in the housing on the feed side of the fluid conditioning structure with a vent that provides a flow path from a region of the housing where the separated fluid from the feed fluid accumulates to the outside of the housing.

17. The method of claim 16 where the fluid conditioning structure is a non-dewetting porous membrane

18. The method of claim 16 where removing separated fluid accumulated in the housing with the separator is regulated by a device comprising a valve.

19. The method of claim 16 wherein vent further comprises a separator that forms a flow path from a region of the housing where the separated fluid from the feed fluid accumulates to the outside of the housing.

20. The method of claim 16 where the separator forms a flow path with a portion of the housing, the inlet of the flow path in a region of the housing where the fluid velocity is less than the feed fluid velocity inlet to the housing.
